(19) United States
(12) Patent Application Publication
(10) Pub. No.: US 2017/0121535 A1
(43) Pub. Date: May 4, 2017

(54) COMPOSITIONS OF AMINOSILOXANES, ALKOXYSILICON COMPOUNDS AND METAL CARBOXYLATES

(71) Applicant: Wacker Chemie AG, Munich (DE)

(72) Inventors: Thomas LEHOTKAY, Muehldorf (DE); Walter EICHBERGER, Kirchberg (AT); Inge SEEGER-FEICHTINGER, Stubenberg (DE)

(73) Assignee: Wacker Chemie AG, Munich (DE)

(21) Appl. No.: 15/320,119

(22) PCT Filed: Sep. 17, 2015
(86) PCT No.: PCT/EP2015/071343

§ 371 Date: Dec. 19, 2016

(30) Foreign Application Priority Data
Oct. 15, 2014 (DE) 10 2014 220 912.9

(51) Int. Cl. C09D 5/16; C14C 9/00; C14C 11/00; C09D 183/14; D06M 15/643

(52) U.S. Cl. CPC C09D 5/1675; C09D 183/14; C09D 5/1687; D06M 15/6436; C14C 11/003; C14C 9/00; C08K 5/098

(57) ABSTRACT

Compositions containing an aminoalkyl-containing polydimethylsiloxane, a silicon compound containing silicon-bonded alkoxy groups, and a zirconium, titanium, or zinc carboxylate catalyst provides water repellency and stain resistance to substrates, particularly woven and non-woven textile and leather substrates.

### CROSS REFERENCE TO RELATED APPLICATIONS

This application is the U.S. National Phase of PCT Appln. No. PCT/EP2015/071343 filed Sep. 17, 2015, which claims priority to German Application No. 10 2014 220 912.9 filed Oct. 15, 2014, the disclosures of which are incorporated in their entirety by reference herein.

### BACKGROUND OF THE INVENTION

1. Field of the Invention

The invention relates to compositions of polydimethylsiloxane comprising aminoalkyl groups, alkoxysilicon compounds and metal carboxylates and their use in the treatment of substrates.

2. Description of the Related Art

Silicone-containing hydrophobicizing agents for textile applications consist predominantly of hydrosiloxane-containing formulations, which display good water-repellent properties. However, hydrosiloxanes are problematical in use because of the release of explosive hydrogen gas at medium to high pH. In addition, the hydrogen formed may occasionally lead to the chemical transformation of dyes.

Hydrosiloxane-free crosslinkable silicone compositions are known:

WO 2012/038293 and WO 2012/038292 describe compositions comprising crosslinkable aminosilicones and MQ resins.

WO 2013/101751 describes a tin-free condensation-crosslinking composition comprising a silyl-containing silicone polymer, a silane or silicate crosslinker and a zirconium salt. These compositions are sealants and are difficult to convert into emulsions and, owing to the moisture sensitivity of some types of catalysts, are not stabilizable in aqueous form.

WO 2005/080666 describes a condensation-crosslinkable composition comprising a silicone resin, a silicate crosslinker and a zirconium salt for water-repellent treatment of textiles. The hand properties of the textiles treated therewith are unsatisfactory.

EP 651089 describes a combination of amino-functionalized polysiloxanes, a high proportion of silica, and metallic esters for treatment of fibers. The improvement of water or oil repellency is not described. The presence of large amounts of silica results in a poorly adherent layer on the substrate surface.

### SUMMARY OF THE INVENTION

The problem addressed by the present invention was that of developing a hydrosiloxane-free crosslinkable silicone-based hydrophobicization recipe that is actually compatible in use. These and other objects are achieved by the invention, which provides compositions (Z) comprising:
(i) 100 parts by weight of an aminoalkyl-containing polydimethylsiloxane(s) (P) having an amine number of not less than 0.05 mequiv/g of polydimethylsiloxane (P), containing units of general formula I

R¹ₐR²_{b}SiO_{((4-a-b)/2)} (I)

where
R¹ represents unsubstituted or halogen-substituted alkyl moieties of 1-40 carbon atoms, —OR or —OH,
R represents unsubstituted or halogen-substituted alkyl moieties of 1-40 carbon atoms,
R² represents aminoalkyl moieties of general formula II

—R³—NR⁴R⁵ (II),
R³ represents divalent hydrocarbon moieties of 1-40 carbon atoms,
R⁴ and R^{4′} each represents monovalent hydrocarbon moieties of 1-40 carbon atoms or H,
R⁵ represents H or a moiety of general formula III

—(R⁶—NR⁴)ₓR⁴ (III),
R⁶ represents a divalent moiety of general formula IV

—(CR^{4′}R^{4′}—)_{y} (IV),
x represents the value 0 or a value from 1 to 40,
y represents the value 1 or 2,
a represents the value 0, 1, 2 or 3,
b represents the value 0, 1, 2 or 3, and
a+b represents an average value from 1.5 to 2.5,
   with the proviso that not more than 20 mol % of the R¹ moieties are OH or OR,
(ii) 1 to 80 parts by weight of silicon compound(s) (S) comprising alkoxy groups bonded to silicon, and
(iii) 0.5 to 15 parts by weight of metal C₁-C₄-carboxylate(s), wherein the metal is selected from Zr(IV), Ti(IV) and Zn(II).

### DETAILED DESCRIPTION OF THE PREFERRED EMBODIMENTS

The compositions (Z) display an outstanding level of water repellency on many substrates, in particular fibers and textiles.

The substrates treated with the compositions (Z) further display an improved level of oil and stain repellency. The readily water-soluble/emulsifiable metal C₁-C₄-carboxylate has, even on its own, a grounding effect which is amplified by the polydimethylsiloxane (P) and the silicon compound (S).

Alkyl moieties R¹ and R may be linear, cyclic, branched, saturated or unsaturated. Alkyl moieties R¹ and R preferably have 1-18 carbon atoms, in particular from 1 to 6 carbon atoms, and methyl and ethyl are particularly preferred. Preferred halogen substituents are fluorine or chlorine. Particularly preferred R¹ moieties are methyl, methoxy, ethoxy or —OH. Preferably, not more than 10 mol % of the R¹ moieties are OH or OR.

The divalent hydrocarbon moieties R³ may be optionally chlorine substituted, linear, cyclic, branched, aromatic, saturated or unsaturated. The R³ moieties preferably have from 1 to 6 carbon atoms, particular preference being given to alkylene moieties, in particular propylene.

Monovalent hydrocarbon moieties R⁴ may be optionally chlorine substituted, linear, cyclic, branched, aromatic, saturated or unsaturated. The R⁴ moieties preferably have from 1 to 6 carbon atoms, and alkyl moieties are particularly preferable. Particularly preferred R⁴ substituents are methyl, ethyl, cyclohexyl and H.

b preferably has the value 0 or 1. a+b preferably has an average value of 1.9 to 2.2.

x preferably has the value 0 or a value from 1 to 18, more preferably from 1 to 6.

Particularly preferred R² moieties are —CH₂N(R⁴)₂, —(CH₂)₃N(R⁴)₂, —(CH₂)₃N(R⁴) (CH₂)₂N(R⁴)₂, in particular aminoethylaminopropyl, aminopropyl and cyclohexylaminopropyl.

Preferably, the polydimethylsiloxane (P) is constructed of no fewer than 3, in particular no fewer than 10 units and preferably not more than 200 units of general formula I.

The ratio of a to b is chosen such that the polydimethylsiloxane (P) has at least an amine number of 0.05 mequiv/g of polydimethylsiloxane (P), preferably not less than 0.2 mequiv/g of polydimethylsiloxane (P). The amine number of polydimethylsiloxane (P) is preferably not more than 7 mequiv/g of polydimethylsiloxane (P).

The viscosity of polydimethylsiloxane (P) is preferably in the range from 1 to 100,000 mPa·s, more preferably from 10 to 50,000 mPa·s, in particular from 10 to 20,000 mPa·s, all at 25° C.

The aminoalkyl groups of polydimethylsiloxane (P) may have been wholly or partly reacted according to known chemical reactions in which, for example, some of the amine moieties may be neutralized with organic or inorganic acids, e.g., formic acid, acetic acid, propionic acid, oleic acid, stearic acid, citric acid, sulphuric acid or hydrochloric acid. When the aminoalkyl groups of polydimethylsiloxane (P) have been neutralized with acids, it is preferable to add an acid in an amount of 0.05 to 1 mole of proton per mole of basic nitrogen atom in the R² moieties.

The polydimethylsiloxanes (P) are prepared via known chemical methods such as, for example, hydrolysis or equilibration.

Silicon compound(s) (S) comprising alkoxy groups bonded to silicon preferably comprises alkoxysilanes, monomeric, oligomeric and polymeric silicate compounds, and silicone resins comprising alkoxy groups bonded to silicon.

Preferably, the silicate compounds are selected from the tetraalkoxysilicate(s) of general formula V

R⁷O₄Si (V),

and a polysilicate compound comprising not less than 80 mol % of units of general formulae VI and VII and 2 or more units of general formula VI

R⁷O₃SiO_{1/2} (VI),

R⁷O₂SiO_{2/2} (VII),

and mixtures thereof, where
R⁷ represents unsubstituted or halogen-substituted hydrocarbon moieties of 1-18 carbon atoms.

The monovalent hydrocarbon moieties R⁷ may be optionally halogen substituted, linear, cyclic, branched, aromatic, saturated or unsaturated. Preferably, the R⁷ moieties have from 1 to 6 carbon atoms and more preferably are alkyl and phenyl moieties. Preferred halogen substituents are fluorine and chlorine. Particularly preferred R⁷ moieties are methyl, ethyl and propyl. A combination of phenyl and methyl is likewise preferable.

Preferably, the polysilicate compound contains not less than 90, in particular not less than 95 mol % of units of general formulae VI and VII.

The remaining units of the polysilicate compound may be, for example, units of general formulae VIII and IX

R⁷OSiO_{3/2} (VIII),

SiO_{4/2} (IX),

where R⁷ has the above meanings.

The silicone resins comprising alkoxy groups bonded to silicon are constructed of not less than 80 mol % of units selected from general formulae X, XI, XII and XIII

R⁸SiO_{1/2} (X),

R⁸SiO_{2/2} (XI),

R⁸SiO_{3/2} (XII),

SiO_{4/2} (XII),

where
R⁸ represents unsubstituted or halogen-substituted monohydric hydrocarbon moieties of 1-40 carbon atoms, —OR⁷ or —OH,
   not less than 80 mol % of the units are selected from general formulae XII and XIII and from 0.5 to 10 mol %, in particular 2 to 5 mol %, of the R⁸ moieties are —OR⁷ moieties,
   where R⁷ has the above meanings.

The monovalent hydrocarbon moieties R⁸ preferably have the preferred meanings of the hydrocarbon moieties R⁷. Methyl, ethyl, propyl, butyl, cyclohexyl, phenyl and their combinations are particularly preferable.

The silicone resins comprising alkoxy groups bonded to silicon are preferably MQ resins and are preferably constructed of not less than 80 mol %, in particular not less than 95 mol % of units selected from the general formulae XII and XIII. The molar ratio of units of general formulae XII:XIII is preferably not less than 0.25, in particular not less than 0.5.

The silicone resins comprising alkoxy groups bonded to silicon are preferably also DT resins and are preferably constructed of not less than 80 mol %, in particular 95 mol % of units selected from the general formulae X and XI. The molar ratio of units of general formulae X:XI is preferably not less than 0.25, in particular not less than 0.5.

The average molecular weight Mn of the silicone resins comprising alkoxy groups bonded to silicon is preferably not less than 200 g/mol, more preferably not less than 1000 g/mol and preferably not more than 100,000 g/mol, in particular not more than 20,000 g/mol.

The compositions (Z) preferably comprise from 5 to 70 parts by weight, in particular from 10 to 50 parts by weight of silicon compound (S) comprising alkoxy groups bonded to silicon.

The metal of tne metal C₁-C₄-carboxylate is preferably Zr(IV) or Zn(II). The metal C₁-C₄-carboxylate is preferably selected from zirconium acetate, zirconium formate, zinc acetate and zinc formate.

The compositions (Z) preferably comprise from 1 to 10 parts by weight of metal C₁-C₄-carboxylate.

The compositions (Z) preferably comprise not more than 0.1 part by weight, in particular not more than 0.01 part by weight of silica.

The compositions (Z) may be in the form of mixtures, solutions or emulsions. The mixtures, solutions or emulsions are readily obtainable, by combining and mixing the individual components in any desired order.

Compositions (Z) in the form of solutions preferably comprise solvents or solvent mixtures having a boiling point/range of up to 120° C. at 0.1 MPa. Examples of such solvents are water; alcohols such as methanol, ethanol, n-propanol, isopropanol, n-amyl alcohol, and i-amyl alcohol; ethers such as dioxane, tetrahydrofuran, diethyl ether, diisopropyl ether, and diethylene glycol dimethyl ether; chlorinated hydrocarbons, such as dichloromethane, and trichloromethane, tetrachloromethane, 1,2-dichloroethane, trichloroethylene; hydrocarbons, in particular aliphatic and aromatic hydrocarbons such as pentane, n-hexane, hexane isomer mixtures, heptane, octane, solvent naphtha, petroleum ether, benzene, toluene, and xylenes; ketones such as acetone, methyl ethyl ketone, diisopropyl ketone and methyl isobutyl ketone (MIBK); esters such as ethyl acetate, butyl acetate, propyl propionate, ethyl butyrate, and ethyl isobutyrate; or mixtures thereof. Hydrocarbons are particularly preferred solvents.

Compositions (Z) in the form of solutions preferably comprise from 10 to 10 000 parts by weight, in particular from 100 to 5000 parts by weight, of solvent.

Compositions (Z) in the form of emulsions preferably comprise emulsifiers and co-emulsifiers. Any prior art ionic and nonionic emulsifiers which can be used to prepare stable aqueous emulsions of organopolysiloxanes are employable, not only singly, but also in mixtures of various emulsifiers. Particular preference is given to fatty alcohol polyglycol ethers, alkylpolyglucosides, alkylphenol polyglycol ethers and quaternary ammonium salts of saturated and unsaturated fatty acids for oil-in-water emulsions. Useful co-emulsifiers include glycols, polyglycols and also alkylpolyglycols.

For water-in-oil emulsions it is possible to use any prior art emulsifiers not only singly but also in mixtures of various emulsifiers. Particular preference is given to sorbitan oleates or stearates, glycerol oleates or stearates, fatty acid glycerol esters or siloxane polyglucosides (as described in EP 0 612 759) in combination with co-emulsifiers such as, for example, fatty alcohol polyglycol ethers, alkylpolyglucosides and nonylphenol polyglycol ethers.

Compositions (Z) in the form of emulsions preferably comprise from 0.1 to 50 parts by weight, in particular from 1 to 20 parts by weight of emulsifier.

Compositions (Z) in the form of emulsions preferably comprise from 100 to 20,000 parts by weight, in particular from 300 to 2000 parts by weight of water. The water may be completely ion-free or salt-containing water, preferably completely ion-free water.

The compositions (Z) are preferably aqueous emulsions or aqueous solutions.

The emulsions preferably contain a protonating agent. The protonating agent is preferably a monoprotic or multiprotic, water-soluble or water-insoluble, organic or inorganic acid, more preferably formic acid, acetic acid, sulphuric acid, hydrochloric acid or citric acid. Protonating agent is preferably added in an amount of 0.05 to 2 moles of proton per mole of basic nitrogen atom in the R² moieties.

In addition to polydimethylsiloxane (P) and silicon compound (S), the compositions (Z) may comprise yet further silicones, for example liquid silicones, cyclic silicones and/or solid silicones, such as silicon-containing waxes. Preference is given to linear polydimethylsiloxanes, preferably having a chainlength of 10 to 500 dimethylsiloxane units and mixtures thereof, since these improve the spreading effect on the substrate.

The compositions (Z) preferably comprise from 0 to 90 parts by weight, more preferably from 10.0 to 60.0 parts by weight, and in particular from 20 to 50 parts by weight of further silicones.

The compositions (Z) may comprise non-silicon-containing waxes, such as natural waxes of vegetable origin, such as carnauba wax and candellila wax, montan acid and montan ester waxes, paraffin waxes, in particular incipiently oxidized synthetic paraffins, polyethylene waxes, polyvinyl ether waxes and metal-soap-containing waxes, of which carnauba wax, paraffin waxes and polyethylene waxes are preferable and paraffin waxes are particularly preferable.

The compositions (Z) preferably comprise from 0 to 100 parts by weight, in particular from 5 to 50 parts by weight, of non-silicon-containing waxes.

The compositions (Z) may comprise thickening agents. Examples of thickening agents are homopolysaccharides, polyacrylates, carboxy- and hydroxymethylcellulose, of which polysaccarides and polyacrylates are particularly preferable.

The compositions (Z) preferably comprise 0 to 60 parts by weight, in particular from 5 to 20 parts by weight of thickening agent.

The compositions (Z) may comprise still further constituents, such as preservatives, scents, acids, alkalis, rust control agents and dyes.

Examples of preservatives are formaldehyde, parabens, benzyl alcohol, propionic acid and salts thereof and also isothiazolinones.

The invention further provides a method of using compositions (Z) in the treatment of porous or aporous, absorbent or nonabsorbent substrates, preferably celluloses, paper, natural and/or synthetic textile fibers, in particular cellulose-based fibers such as cotton, viscose, cupro, regenerated-cotton fibers, animal fibers such as wool and silk, synthetic fibers such as polyester, polyamide, polyacrylonitrile, polypropylene and polyethylene, and also fiber blends, and woven and knitted textile fabrics, nonwovens, and carpets made from the fibers, mineral building materials, stone, tiles, marble, metals, coated metals, glass, ceramics, glass ceramic, plastics, coated plastics, wood, laminate, cork, rubber, leather substitute, leather and cosmetic applications, e.g., skin and hair. It is particularly preferred to use the compositions (Z) for the impregnation of textiles and leather.

The above symbols in the above formulae all have their respective meanings independently of each other. The silicon atom is tetravalent in all formulae. The sum total of all constituent parts of compositions (Z) add up to 100 wt %.

The amine number in mequiv/g corresponds to the amount of nitrogen in mmol in 1 g of substance.

The amine number is determined as the number of ml of 1N HCl which is needed to neutralize 1 g of substance.

In the examples which follow, all amounts and percentages are by weight, all pressures are 0.10 MPa (abs.) and all temperatures are 25° C. unless otherwise stated. All viscosities are measured at 25° C.

### Examples

### Example 1 (Reference, not in Accordance with the Present Invention)

5.3 g of tridecyl alcohol ethoxylate (available as LUTENSOL® TO from BASF SE) are mixed with 1.7 g of water. 29.0 g of hydrogenpolysiloxane (available from Wacker Chemie AG) are added dropwise. This is followed by emulsification and thinning with 0.2 g of acetic acid (available from Sigma-Aldrich Chemie GmbH) and 64.0 g of water. The formulation is mixed with zirconium acetate.

### Example 2a

2.5 g of silicone resin [[Me₃SiO_{1/2}]_{0.373} [SiO₂]_{0.627}]₄₀, (Mₙ=2700 g/mol, the resin consists of 0.2% OH and 3.1% OEt) are dissolved in 2.0 g of ethylene glycol monohexyl ether (available from Sigma-Aldrich Chemie GmbH), and 1.1 g of tridecyl alcohol ethoxylate (see EXAMPLE 1) are admixed with stirring. Then, 14.5 g of aminosilicone oil (viscosity 1000 mm²/s at 25° C., functional moieties —(CH₂)₃NH(CH₂)₂NH₂; amine number 0.4 mequiv/g, 47 mol % of SiMe₃ end groups, 47 mol % of SiMe₂OH end groups and 6 mol % of SiMe₂OMe end groups) are admixed at 25° C. The mixture is emulsified with 79.9 g of water to obtain a clear, colorless solution.

The formulation is mixed with zirconium acetate.

### Example 2b

EXAMPLE 2a is repeated except that the zirconium acetate solution is replaced by zinc acetate solution consisting of 2.0 g of zinc acetate dihydrate (available from Sigma-Aldrich Chemie GmbH) dissolved in 7.0 g of water and 1.0 g of acetic acid.

### Example 3

3.0 g of tetraethyl silicate (yields 41% of silicon dioxide on complete hydrolysis) and 14.0 g of aminosilicone oil (viscosity about 950 mm²/s at 25° C., functional moieties —(CH₂)₃NH(CH₂)₂NH₂; amine number 0.5 mequiv/g, 47 mol % of SiMe₃ end groups, 47 mol % of SiMe₂OH end groups, 6 mol % of SiMe₂OMe end groups) are dissolved in 3.0 g of ethylene glycol monohexyl ether and mixed with 1.1 g of tridecyl alcohol ethoxylate and 5.0 g of butylcarbitol (available from Sigma-Aldrich Chemie AG) and 7.0 g of water and then emulsified with 73.9 g of water and 0.2 g of acetic acid to obtain a milky solution at 25° C. The formulation is mixed with zirconium acetate.

### Example 4

2.5 g of silicone resin [[Me₃SiO_{1/2}]_{0.373}[SiO₂]_{0.627}]₄₀, (Mₙ=2700 g/mol, the resin consists of 0.2% OH and 3.1% OEt) and 3.8 g of polydimethylsiloxane (viscosity 350 mm²/s at 25° C.) are mixed with 1.1 g of ethylene glycol monohexyl ether and 14.5 g of aminosilicone oil (viscosity 1000 mm²/s at 25° C., functional moieties; —(CH₂)₃NH₂; amine number 0.4 mequiv/g, 47 mol % of SiMe₃ end groups, 47 mol % of SiMe₂OH end groups, 6 mol % of SiMe₂OMe end groups). This mixture is mixed with 1.3 g of tridecyl alcohol ethoxylate and 4 g of butylcarbitol and emulsified with 0.2 g of acetic acid and 72.8 g of water at 25° C. to form a milky solution.

The formulation is mixed with zirconium acetate.

### Example 5

2.5 g of methylphenylsilicone resin (M_{w}=1030 g/mol, Mₙ=730; polydispersity 1.4, viscosity 140 mm²/s at 25° C. and 18.3% by weight of SiOMe and 0.24% by weight of Si—OH groups on the surface, consisting of 55 mol % PhSiO_{3/2} units, 40 mol % of Me₂SiO_{2/2} units and 5 mol % of Me—Si(O)_{3/2} units) is mixed with 1.1 g ethylene glycol monohexyl ether and 14.5 g of aminosilicone oil (viscosity 1100 mm²/s at 25° C., functional moieties —(CH₂)₃NH(CH₂)₂NH₂; amine number 0.3 mequiv/g, 47 mol % of SiMe₃ end groups, 47 mol % of SiMe₂OH end groups, 6 mol % of SiMe₂OMe end groups) and 1.3 g of tridecyl alcohol ethoxylate (see EXAMPLE 1) and 4 g of butylcarbitol and emulsified with 0.2 g of acetic acid and 76.6 g of water to obtain a milky solution at 25° C.

The formulation is mixed with zirconium acetate.

### Example 6

2.5 g of a methylsilicone resin (consisting of 98% Me—Si(O)_{3/2} units and 2% Me₂Si(O)_{2/2} units with an additional 5.8% by weight of ethoxy groups and 0.9% by weight of OH groups on the surface) are mixed with 1.1 g of ethylene glycol monohexyl ether and 14.5 g of aminosilicone oil (viscosity 1000 mm²/s at 25° C., functional moieties —(CH₂)₃NH(CH₂)₂NH₂; amine number 0.5 mequiv/g, 47 mol % of SiMe₃ end groups, 47 mol % of SiMe₂OH end groups, 6 mol % of SiMe₂OMe end groups) and 1.3 g of tridecyl alcohol ethoxylate and 4 g of butylcarbitol (described in EXAMPLE 1) and emulsified with 0.2 g of acetic acid and 76.6 g of water to form a milky solution at 25° C.

The formulation is mixed with zirconium acetate.

### Example 7

A 5×5×0.2 cm piece of wet blue cattlehide crust is soaked with the 1% solution of the described EXAMPLE 3 for 2 hours at room temperature. The sample is dried at 50° C. for 24 hours and tested in a penetrometer machine (available from PFI Pirmasens, Germany).

The leather specimen is tested until the water penetrates through the leather cross section. See Table 2.

### Example 8

A 5×5×0.2 cm piece of wet blue cattlehide crust is soaked with the 1% solution of the described EXAMPLE 4 for 2 hours at room temperature. The sample is dried at 50° C. for 24 hours and tested in a penetrometer machine (see EXAMPLE 7).

The leather specimen is tested until the water penetrates through the leather cross section. See Table 2.

The formulations are applied to the particular substrate using a pad-mangle (available from Mathis AG, Switzerland) in accordance with the mixing ratios with zirconium acetate solution (as a 15% solution in acetic acid, available from Sigma-Aldrich Chemie GmbH) or zinc acetate solution (Example 2b) which are reported in the tables.

TABLE 1

| | | Zirconium | |
|---|---|---|---|
| | Amount | acetate or | |
| EXAMPLE | used | zinc acetate (1) | Spray |
| no. | [g/l] | [g/l] | test |
| 1* | 40 | 6.0 | 90 |
| | | | (cotton) |
| 2a | 50 | 5.2 | 90 |
| | | | (cotton) |
| 2b | 50 | 7.2(1) | 90 |
| | | | (cotton) |
| 3 | 50 | 5.7 | 100 |
| | | | (cotton-polyester |
| | | | blend) |
| 4 | 50 | 5.8 | 100 |
| | | | (polyamide) |
| 5 | 50 | 6.2 | 100 |
| | | | (wool) |
| 6 | 50 | 6.4 | 90 |
| | | | (viscose) |
| untreated* | | | 0 |
| | | | (cotton) |

*not in accordance with the present invention

Liquor pick-up about 30-50%

Drying and curing: 3 min at 150° C.

### Spray Test:

as per Textile Standard AATCC 22

TABLE 2

| EXAMPLE | | Time |
|---|---|---|
| no. | Product | [min] |
| 7 | EXAMPLE 3 | 40 |
| 8 | EXAMPLE 4 | 45 |
| untreated | | 15 |

5×5×0.2 cm wet blue cattlehide crust

TABLE 3

| | | Soil release | | | |
|---|---|---|---|---|---|
| EXAMPLE | Stain | | | Chocolate | Grape |
| no. | repellency | Germ oil | Ketchup | syrup | juice |
| 1* | 1 | 2.5 | 3 | 2 | 3.5 |
| 2a | 5 | 4 | 4.5 | 2.5 | 5 |
| 3 | 5 | 3.5 | 4 | 3 | 5 |
| 4 | 3 | 3.5 | 4.5 | 2.5 | 5 |
| 5 | 2 | 3.5 | 4.5 | 2.5 | 5 |
| 6 | 3 | 3.5 | 4.5 | 2.5 | 5 |
| untreated* | 1 | 3 | 3 | 2 | 5 |

*not in accordance with the present invention

### Test of Stain Repellency:

0.5 ml test soil (grape juice) is applied to a woven cotton fabric and covered with a piece of cookery paper. A weight of 200 g is then placed on top for 60 sec. Subsequently, the weight is removed and the soil is wiped off with a paper tissue.

Evaluation: 1=absorption; 5=complete stain repellency (no absorption)

Test of Soil Release:

The soiled specimens are air dried for one hour and subsequently washed.

Washing Conditions:

MIELE NOVOTRONIC washing machine: “Synthetics” wash cycle with high water level: 59 min; 40° C., 600 rpm. 1.8 kg load of soiled specimens and ballast are washed with 30.0 g of PERSIL® Color Gel (available from UNILEVER) and subsequently dried.

Evaluation: as per AATCC 9 “Step Chromatic Transference Scale” (1=strong transference; 5=no transference)

Germ oil: MAZOLA germ oil, UNILEVER Hamburg, Germany

Ketchup: HEINZ Tomato Ketchup, Düsseldorf, Germany

Chocolate syrup: HERSHEY'S Chocolate Syrup, Pennsylvania, USA

Grape juice: POELZ Traubensaft, Garching, Germany

1.-10. (canceled)

11. A water and stain-resistant composition, comprising:
(i) 100 parts by weight of at least one aminoalkyl-containing polydimethylsiloxane having an amine number of not less than 0.05 mequiv/g of polydimethylsiloxane, comprising units of formula I
R¹ₐR²_{b}SiO_{(4-a-b/2)} (I),
where
R¹ are unsubstituted or halogen-substituted alkyl moieties of 1-40 carbon atoms, —OR or —OH,
R are unsubstituted or halogen-substituted alkyl moieties of 1-40 carbon atoms,
R² are aminoalkyl moieties of formula II
—R³—NR⁴R⁵ (II),
R³ are divalent hydrocarbon moieties of 1-40 carbon atoms,
R⁴ and R^{4′} are monovalent hydrocarbon moieties of 1-40 carbon atoms, or H,
R⁵ are H or a moiety of formula III
(R⁶NR⁴)ₓR⁴ (III),
R⁶ are divalent moieties of formula IV
—(CR^{4′}R^{4′}—)y (IV),
x is 0 or an integer from 1 to 40,
y is 1 or 2,
a is 0, 1, 2 or 3,
b is 0, 1, 2 or 3, and
a+b has an average value from 1.5 to 2.5,
with the proviso that not more than 20 mol % of the R¹ moieties are OH or OR,
(ii) 1 to 80 parts by weight of one or more silicon compound(s) comprising alkoxy groups bonded to silicon, and
(iii) 0.5 to 15 parts by weight of metal C₁-C₄-carboxylates, wherein at least one metal is selected from the group consisting of Zr(IV), Ti(IV) and Zn(II).

12. The composition of claim 11, wherein the R⁴ moieties are alkyl moieties having 1 to 6 carbon atoms.

13. The composition of claim 11, wherein at least one R² moiety is selected from the group consisting of —CH₂N(R⁴)₂, —(CH₂)₃N(R⁴)₂, and —(CH₂)₃N(R⁴)(CH₂)₂N(R⁴)₂.

14. The composition of claim 12, wherein at least one R² moiety is selected from the group consisting of —CH₂N(R⁴)₂, —(CH₂)₃N(R⁴)₂, and —(CH₂)₃N(R⁴)(CH₂)₂N(R⁴)₂.

15. The composition of claim 11, wherein the silicon compound(s) comprising alkoxy groups bonded to silicon are alkoxysilanes, monomeric, oligomeric or polymeric silicate compounds, or silicone resins comprising alkoxy groups bonded to silicon.

16. The composition of claim 12, wherein the silicon compound(s) comprising alkoxy groups bonded to silicon are alkoxysilanes, monomeric, oligomeric or polymeric silicate compounds, or silicone resins comprising alkoxy groups bonded to silicon.

17. The composition of claim 13, wherein the silicon compound(s) comprising alkoxy groups bonded to silicon are alkoxysilanes, monomeric, oligomeric or polymeric silicate compounds, or silicone resins comprising alkoxy groups bonded to silicon.

18. The composition of claim 15, wherein at least one silicate compound comprises a tetraalkoxysilicate of formula V
(R⁷O)₄Si (V),
or a polysilicate compound comprising not less than 80 mol % of units of formulae VI and VII and 2 or more units of formula VI
(R⁷O)₃SiO_{1/2} (VI),
(R⁷O)₂SiO_{2/2} (VII),
and mixtures thereof, where
R⁷ are unsubstituted or halogen-substituted hydrocarbon moieties of 1-18 carbon atoms.

19. The composition of claim 15, wherein the silicone resins comprising alkoxy groups bonded to silicon comprise not less than 80 mol % of units selected from formulae X, XI, XII and XIII
R⁸₃SiO_{1/2} (X),
R⁸₂SiO_{2/2} (XI),
R⁸SiO_{3/2} (XII),
SiO_{4/2} (XIII),
where
R⁸ are unsubstituted or halogen-substituted monohydric hydrocarbon moieties of 1-40 carbon atoms, —OR⁷ or —OH,
not less than 80 mol % of the units are selected from general formulae XII and XIII, and from 0.5 to 10 mol % of the R⁸ moieties are —OR⁷ moieties, where
R⁷ are unsubstituted or halogen-substituted hydrocarbon moities of 1-18 carbon atoms.

20. The composition of claim 11, wherein at least one metal C₁-C₄-carboxylate is selected from the group consisting of zirconium acetate, zirconium formate, zinc acetate, and zinc formate.

21. The composition of claim 11, which is in the form of an aqueous emulsion or in the form of an aqueous solution.

22. In a method for treating of porous or non-porous, absorbent or nonabsorbent substrates to increase water repellency and/or stain resistance, the improvement comprising treating a substrate with a composition of claim 11.

23. The method of claim 22, wherein the step of treating comprises impregnating a textile or leather substrate with the composition.
